(19) United States
(12) Patent Application Publication
(10) Pub. No.: US 2026/0331877 A1
(43) Pub. Date: Oct. 22, 2026

(54) SPARK PLUG FOR IGNITING A COMBUSTIBLE GASEOUS FUEL MIXTURE IN AN INTERNAL COMBUSTION ENGINE

(71) Applicant: INNIO Jenbacher GmbH & Co OG, Jenbach (AT)

(72) Inventors: Wolfgang Fimml, Maurach in Tirol (AT); Rafal Pyszczek, Warschau (PL); Thomas Fankhauser, Finkenbert (AT); Matthias Raibel, Innsbruck (AT); Adam Weall, Jenbach (AT)

(21) Appl. No.: 19/654,459

(22) Filed: Apr. 22, 2026

(30) Foreign Application Priority Data
Apr. 22, 2025 (EP) 25171698

(51) Int. Cl. H01T 13/46

(52) U.S. Cl. CPC H01T 13/46

(57) ABSTRACT

Spark plug for igniting a combustible gaseous fuel mixture in an internal combustion engine, wherein the spark plug comprises a longitudinal extent along a longitudinal axis, wherein at a first end facing the combustion chamber when the spark plug is mounted in the internal combustion engine at least one middle electrode and at least two ground electrodes are provided, wherein at least two spark gaps are provided which are arranged between the middle electrode and each of the at least two ground electrodes respectively, wherein the at least two spark gaps are arranged asymmetrically with respect to the middle electrode or the longitudinal axis of the spark plug.

### CROSS-REFERENCE TO RELATED APPLICATION

This application claims priority to and benefit of European Patent Application No. EP 25171698.1, filed on Apr. 22, 2025, entitled “SPARK PLUG FOR IGNITING A COMBUSTIBLE GASEOUS FUEL MIXTURE IN AN INTERNAL COMBUSTION ENGINE”, which is herein incorporated by reference in its entirety for all purposes.

### FIELD OF THE INVENTION

The present disclosure relates to a spark plug for igniting a combustible gaseous fuel mixture in an internal combustion engine, an arrangement comprising such a spark plug and a component part for receiving at least part of the spark plug, as well as an internal combustion engine having such an arrangement and/or spark plug and the use of such a spark plug.

### BACKGROUND

During operation of the internal combustion engine an air-fuel mixture is ignited by an spark plug and combusted inside the combustion chamber, wherein during the combustion the expansion of the high-temperature and high-pressure gases are mainly used and transmitted into mechanical energy.

To increase efficiency, it is desirable to improve the ignition process, wherein it would be preferable if the whole or as much as possible air-fuel mixture inside the combustion process ignites at the same time.

Starting with a certain size of internal combustion engines, in particular gas engines, it is beneficial to use ignition amplifiers, in order to properly ignite the air-fuel-mixture, preferably a diluted and/or lean air-fuel-mixture, in the large volume of the cylinders.

Pre-chambers usually serve as ignition intensifiers, wherein the fuel-air mixture that is highly compressed at the end of the compression stroke is ignited in a relatively small secondary space (a pre-chamber volume) separate from the main combustion chamber of the cylinders, wherein the combustion of the pre-chamber passes over, e.g. via transfer passages fluidically connecting the pre-chamber volume with the main combustion chamber, into the main combustion chamber and ignites the compressed air-fuel mixture in the main combustion chamber.

But furthermore, also in operation of pre-chambers it would be beneficial to generate high (combustion) pressure to generate preferably quick and long ignition torches passing via the transfer passages into the main combustion chamber.

Therefore, it is known by the state of the art to provide pre-chambers having pear shaped pre-chamber volume geometries, wherein a spark plug is arranged centrical in the upper part of the pre-chamber volume to provide a symmetrical ignition which study moves downward in direction of the transfer passages

But it is still desirable to develop new techniques for providing more effective solutions for igniting air-fuel mixtures in combustion chambers of the internal combustion engines.

### BRIEF DESCRIPTION

Therefore, the object of the present disclosure is to provide a possibility to ignite an air fuel mixture of an internal combustion engine with improved efficiency.

This object is achieved by a spark plug for igniting a combustible gaseous fuel mixture in an internal combustion engine with the features of claim 1, an arrangement comprising such a spark plug with the features of claim 14, an internal combustion engine having such an arrangement and/or spark plug and the use of such a spark plug, as well as by the usage of such a spark plug.

Accordingly, a spark plug for igniting a combustible gaseous fuel mixture in an internal combustion engine comprises a longitudinal extent along a longitudinal axis, wherein at a first end facing the combustion chamber when the spark plug is mounted in the internal combustion engine at least one middle electrode and at least two ground electrodes are provided, wherein at least two spark gaps are provided which are arranged between the middle electrode and each of the at least two ground electrodes respectively, wherein the at least two spark gaps are arranged asymmetrically with respect to the middle electrode or the longitudinal axis of the spark plug.

Tests of the applicant have surprisingly shown that the combustion process can be improved by igniting an air-fuel mixture by an ignition provided eccentrically in an upper region of the combustion chamber.

Such an eccentrical igniting does initiate a combustion process firstly spreading in the upper region around the whole circumference of the combustion chamber before burning down along the combustion chamber, wherein a much higher efficiency of the combustion process can be achieved.

The longitudinal axis can in many instances be parallel to an axis along which a translation happens when the spark plug is screwed into a thread in the cylinder head or spark plug sleeve, the longitudinal axis being arranged centrally with respect to the thread.

Advantageous embodiments of the disclosure are defined in the dependent claims.

It can be provided that the at least two ground electrodes are arranged in an azimuthal area spanning 170 degrees, preferably 145 degrees, particularly preferably 120 degrees, in relation to the longitudinal axis and/or the at least one middle electrode.

It can be provided that that the at least two ground electrodes are arranged in an azimuthal area spanning 170 degrees, preferably 145 degrees, particularly preferably 120 degrees, seen orthogonal with respect to the longitudinal axis.

Preferably it can be provide that a flow control element is provided partially surrounding the middle electrode, preferably with respect to the longitudinal axis.

The flow control element can be arranged opposite of the at least two ground electrodes with respect to the longitudinal axis.

Alternatively, it can also be provide that the flow control element as well as the at least two spark gaps are arranged asymmetrically with respect to the middle electrode or the longitudinal axis of the spark plug, wherein the flow control element and the at least two spark gaps are arranged in azimuthal areas different from each other in relation to the longitudinal axis and/or the at least one middle electrode, i.e., the flow control element and the middle electrode can be arranged not strictly opposite from each other.

It can be provided that the flow control element is arranged in an azimuthal area spanning 170 degrees, preferably 145 degrees, particularly preferably 120 degrees, in relation to the longitudinal axis and/or the at least one middle electrode.

The flow control element can be formed by at least one separate component part, which at least one separate component part is arranged at, preferably mounted at, a housing of the spark plug, particularly preferably wherein the housing and the at least one separate component part are connected by welding, particularly preferably laser beam welding.

It can also be provided that the flow control element can be formed by at least one separate component part, which at least one separate component part is arranged at, preferably mounted at, the middle electrode or the ground electrode of the spark plug, particularly preferably wherein the middle electrode or the ground electrode and the at least one separate component part are connected by welding, particularly preferably laser beam welding.

Alternatively, it can be provided that the flow control element can be formed by at least one separate component part, which at least one component part is mounted, preferably clamped, between the spark plug and the cylinder head and/or spark plug sleeve.

It can be provided that the flow control element has a base shape of a part of a cylinder, preferably a circular cylinder.

It can also be provided that the flow control element has a base shape of a part of a triangle and/or polygon.

A central electrode carrier can be provided extending along the longitudinal axis, wherein at least one middle electrode is attached to the electrode carrier.

It can be provided that the at least one middle electrode projects, preferably orthogonally with respect to the longitudinal axis, from the electrode carrier towards the at least two ground electrodes.

The at least two ground electrodes can be fixed, preferably welded, particularly preferably laser beam welded, to a housing of the spark plug.

The housing of the spark plug can be provided by a mounting portion for mounting the spark plug in the internal combustion engine, the mounting portion preferably being a thread.

It can be provided that the housing, and preferably the thread, is defining the longitudinal axis of the spark plug. In other words: It can be provided that the longitudinal axis of the spark plug is defining the center of the housing and/or the thread.

An electrical connection for connecting the spark plug with an electrical power supply can be arranged at a second end of the spark plug facing away from the first end.

It can be provided that the at least two spark gaps are arranged asymmetrically with respect to the middle electrode and the longitudinal axis of the spark plug.

Furthermore, protection is sought for an arrangement for an internal combustion engine comprising an igniter for igniting an air fuel mixture comprising a spark plug according to at least one of the preceding claims and a component part for receiving at least part of the spark plug, preferably wherein the spark plug is disposed in the component part in a given azimuthal position relative to the longitudinal axis, wherein there is provided a positioning device functioning to lock the spark plug in the given azimuthal position.

By use of the component part and the positioning device functioning to lock the spark plug in the given azimuthal position the spark plug can exactly be arranged relatively to the component part, especially with regard to a rotational position.

Such an exactly positioning of the spark plug allows to orient the spark plug to given thermal and/or fluidical properties already being present in the combustion chamber, wherein this thermal and/or fluidical properties can be used to actively affect the thermal impact on the igniter during the combustion process.

It can be provided that the azimuthal position provides a relative positioning between the spark plug and the component part, that an given fluidically flow in or through the combustion chamber (for instance an air, fuel or air-fuel mixture supplied into the combustion chamber) is directed at the igniter, e.g., the spark gap of the igniter, wherein the fluid flow (especially between the combustion strokes) can be used to actively affect (preferably cool) the igniter.

Therefore, in an exemplary embodiment, air, fuel or air-fuel mixture supplied to the combustion chamber or a pre-chamber can be used for active cooling of the igniter, preferably the spark plug.

The given azimuthal position of the spark plug relative to the longitudinal axis according to the present disclosure can be understood as the angular position of the igniter given the longitudinal axis as turning axis.

The longitudinal axis can in many instances be an axis along which a translation happens when the spark plug is screwed into a thread in the cylinder head or spark plug sleeve.

It can be provided that the positioning device is securable or secured in the component part and/or integral with the component part.

The positioning device can be provided by a latch, preferably with a longitudinal extend along a centerline of the latch, particularly preferably wherein the centerline of the latch is provided oblique or orthogonal with respect to the longitudinal axis of the spark plug.

The latch can be provided in the form of a pin or by a grub screw.

The positioning device can be provided by a locking profile disposed on the igniter, wherein the latch and the locking profile cooperate for locking the igniter in the given azimuthal position.

The locking profile can be provided by a recess, preferably a groove and/or a bore.

The component part can be provided by a spark plug sleeve or a pre-chamber sleeve disposing the igniter in such a way, that an electrode of the spark plug protrudes into a combustion chamber and/or a pre-combustion chamber of the internal combustion chamber.

It can be provided that the component part carries or provides a pre-chamber component part and the spark plug is configured to ignite a combustible air-fuel mixture inside a pre-chamber volume of the pre-chamber component part.

At least one pre-chamber gas channel can be provided for supplying air, fuel or an air-fuel mixture to the pre-chamber volume.

It can be provided that the component part comprises the at least one pre-chamber gas channel, preferably the at least one pre-chamber gas channel can be provided by at least one bore at least partially through the component part.

It can be provided that the pre-chamber gas channel provides a fluid connection to a pre-chamber gas valve or a pre-chamber gas injector.

The given azimuthal position of the spark plug can be provided in such a way that the supplied air, fuel or an air-fuel mixture via the pre-chamber gas channel is directed to the spark gap, middle electrode and/or ground electrode when entering the pre-chamber.

It can be provided that an exit part of the pre-chamber gas channel is aligned with the spark gap, middle electrode and/or ground electrode when the igniter is in the given azimuthal position.

Furthermore, protection is sought for an internal combustion engine a spark plug and/or an arrangement according to the present disclosure.

Also, protection is sought for the use of a spark plug in an arrangement and/or an internal combustion engine according to the present disclosure.

### BRIEF DESCRIPTION OF THE DRAWINGS

Further details and advantages are apparent from the accompanying figures and the following description of the drawings. The figures show:

FIG. 1 illustrates a first embodiment of an arrangement for an internal combustion engine comprising an igniter,

FIG. 2 illustrates a second embodiment of an arrangement for an internal combustion engine comprising an igniter,

FIG. 3 illustrates a third embodiment of an arrangement for an internal combustion engine comprising a spark plug,

FIG. 4 illustrates a detail view of FIG. 3, and

FIG. 5 illustrates the spark plug of FIG. 4 and 5 in isolation.

### DETAILED DESCRIPTION

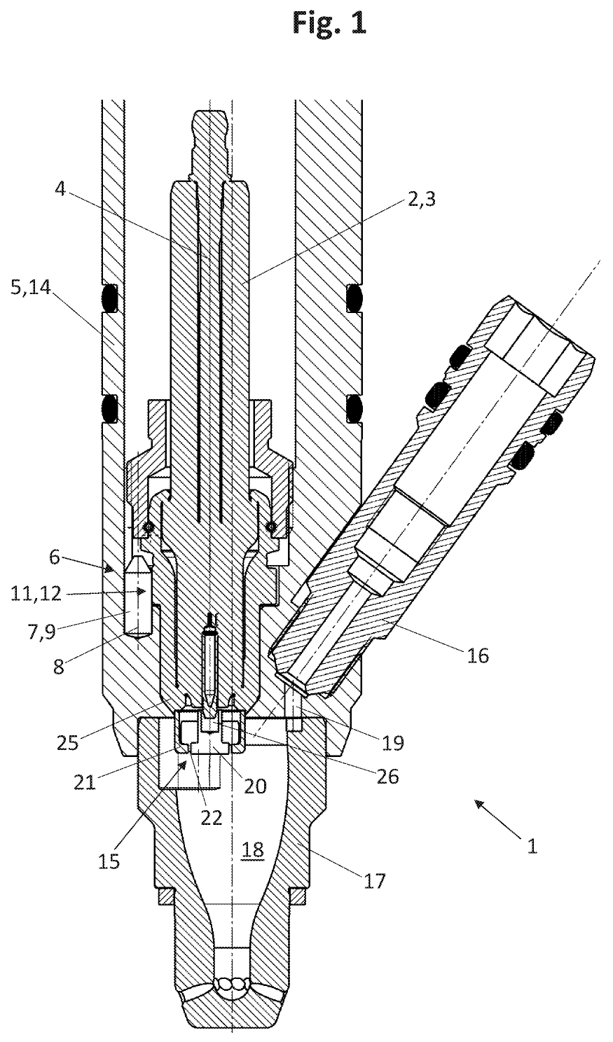

FIG. 1 discloses a first embodiment of an arrangement 1 for an internal combustion engine comprising an igniter 2, wherein the igniter 2 of this embodiment is provided by a spark plug 3.

The pre-chamber volume 18 shown by this specific embodiment is formed by two separate components which form a cavity in the mounted state. The upper part forming the pre-chamber volume 18 is a spark plug sleeve 14 and the lower part a pre-chamber component part 17 which are connected.

The spark plug sleeve 14 and the pre-chamber component part 17 are placed in a cylinder head (not shown for reasons of clarity) of an internal combustion engine, wherein the pre-chamber component part 17 (forming the distal end of the arrangement 1) protrudes into a main combustion chamber of the internal combustion chamber.

The spark plug sleeve 14 carries the pre-chamber injector 16 and the spark plug 3, wherein the spark plug sleeve 14 comprises an upper opening which forms the proximal end of the arrangement 1.

The pre-chamber injector 16 is fluidically connected to the pre-chamber gas channel 19.

By use of the pre-chamber gas channel 19 and the pre-chamber injector 16 air, fuel or and air-fuel-mixture can be supplied to the pre-chamber volume 18.

The pre-chamber gas channel 19 is arranged partially arranged in the spark plug sleeve 14 and partially arranged in the pre-chamber component part 17.

The spark plug 3 is mounted at the spark plug sleeve 14 disposing the spark plug 3 in such a way, that an ignition device 15 of the spark plug 3 protrudes into the pre-combustion volume 18 of the internal combustion chamber.

In this embodiment the spark plug 3 providing the igniter 2 is provided inside the spark plug sleeve 14, which spark plug sleeve 14 provides the component part 5.

The spark plug 3 comprises a middle electrode 20 and ground electrodes 21, wherein between the middle electrode 20 and the ground electrodes 21 a spark gap 22 is present.

Furthermore, the spark plug 3 and the spark plug sleeve 14 are provided by a positioning device 6 functioning to lock the spark plug 3 in the given azimuthal position.

The positioning device 6 comprises a latch 7 with a longitudinal extension along a centerline 8 of the latch 7, wherein the centerline 8 of the latch 7 is provided parallel with respect to the longitudinal axis 4 of the spark plug 3.

The latch 7 of the embodiment of FIG. 1 is provided by a pin 9.

Furthermore, the positioning device 6 comprises a locking profile 11 disposed on the spark plug 3, wherein the pin 10 and the locking profile 11 cooperate for locking the spark plug 3 in the given azimuthal position.

The locking profile 11 of this embodiment is provided by a groove 12, wherein the groove 12 is manufactured at the spark plug 3, preferably by milling.

The given azimuthal position of the spark plug 3 is provided in such a way that the supplied air, fuel or an air-fuel mixture via the pre-chamber gas channel 19 is directed to the spark gap 22, the middle electrode 20 and the ground electrode 21 when entering the pre-chamber volume 18.

Therefore, the air, fuel or air-fuel mixture supplied to the pre-chamber volume 18 can be used for active cooling of the ignition device 15, wherein a possibility is provided to actively cool the ignition device 15 of the spark plug 3 and therefore provide an alternative or additional way of heat dissipation from the spark plug 3.

By use of such a configuration the electrodes 20, 21 of the spark plug 3 effected to the highest thermal conditions can be cooled in the most effective way.

By positioning the spark plug 3 in a given azimuthal position the ignition between the electrodes 20, 21 can be positioned exactly, wherein an ideal position of the start of ignition can be provided.

By providing an ignition eccentrically in an upper region of the pre-combustion volume 18 the combustion process firstly spreads in the upper region around the whole circumference of the pre-combustion volume 18 before burning down along the longitudinal axis 4, wherein a much higher efficiency of the combustion process can be achieved.

By use of a nearly symmetrical expansion of the combustion process downward along the longitudinal axis 4 a much higher combustion peak pressure inside the pre-chamber volume 18 can be reached, wherein the flame jet passing through the transfer passages 23 into a main combustion chamber of an internal combustion engine to ignite an air-fuel mixture in the main combustion chamber can be increased regarding their speed an length entering the main combustion chamber of the internal combustion engine.

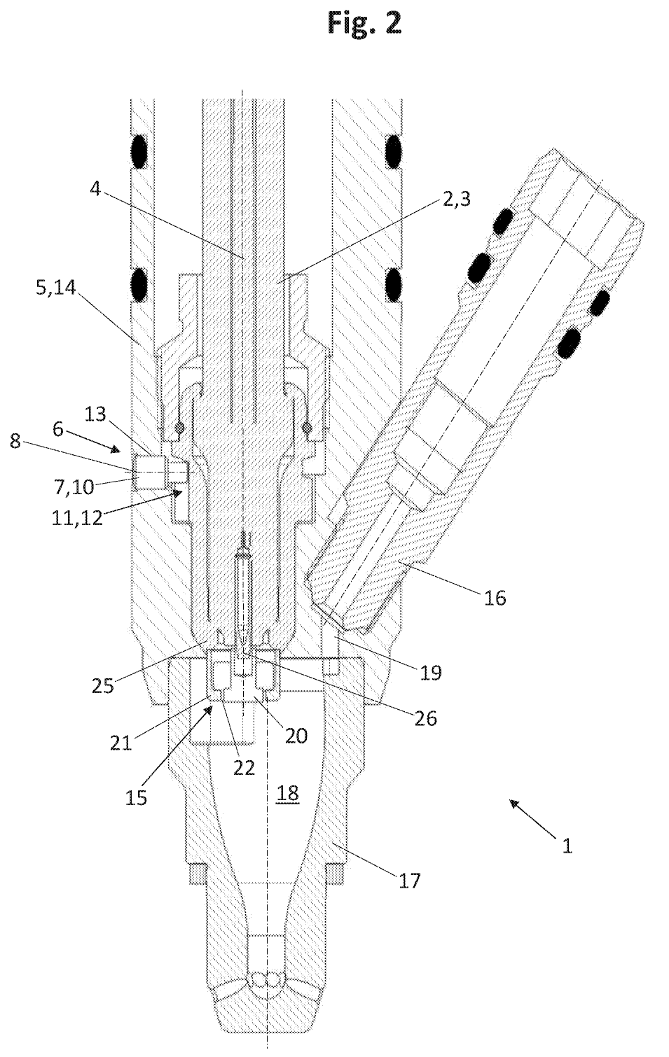

FIG. 2 discloses a second embodiment of an arrangement 1 for an internal combustion engine comprising an igniter 2, wherein the igniter 2 of this embodiment is provided by a spark plug 3.

In contrast to the embodiment of FIG. 1 the second embodiment disclosed of FIG. 2 discloses different positioning device 6, wherein the positioning device 6 comprises a latch 7 with a longitudinal extension along a centerline 8, wherein the centerline 8 of the latch 7 is provided oblique or orthogonal with respect to the longitudinal axis 4 of the igniter 2.

The latch 7 is provided in this embodiment in the form of a grub screw 10, screwed or arranged inside a bore 13 of the spark plug sleeve 14.

The grub screw 10 can be screwed against or inside the groove 12 (functioning as the locking profile 11) of the spark plug 3.

Therefore, the first embodiment of FIG. 1 and the second embodiment of FIG. 2 manly differ by the positioning device 6 (comprising the latch 7 and the locking profile 11). The remaining characteristics are essentially the same.

FIGS. 1 and 2 disclose embodiments of arrangements comprising spark plugs 3 known in the state of the art having a symmetric arrangement of the electrodes 20, 21.

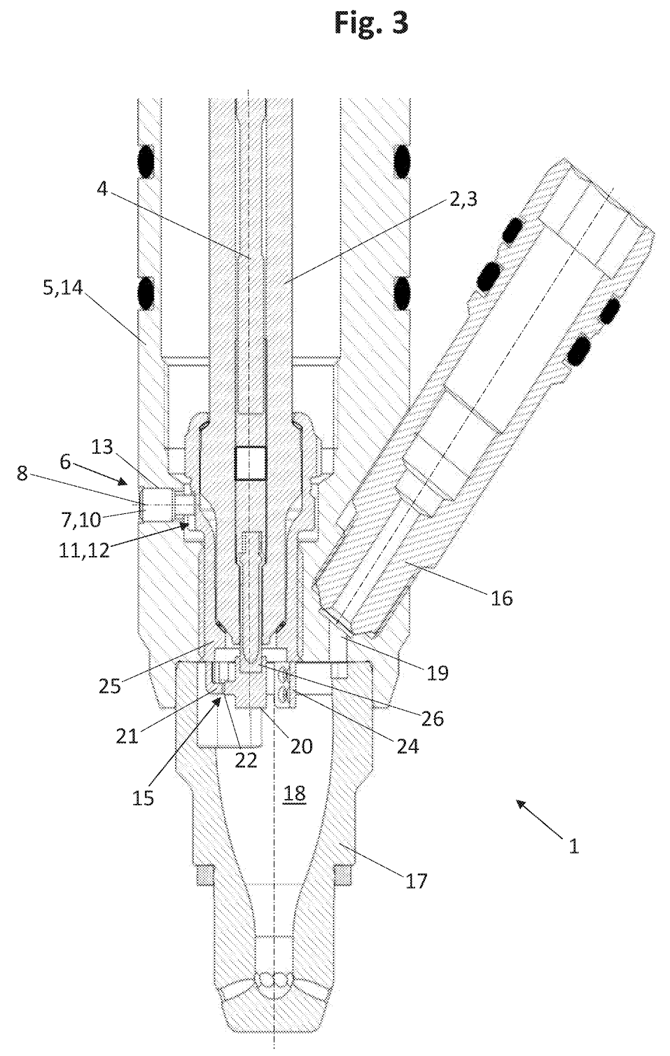

FIG. 3 discloses an arrangement (especially compared to FIG. 2) having a different Type of a spark plug 3).

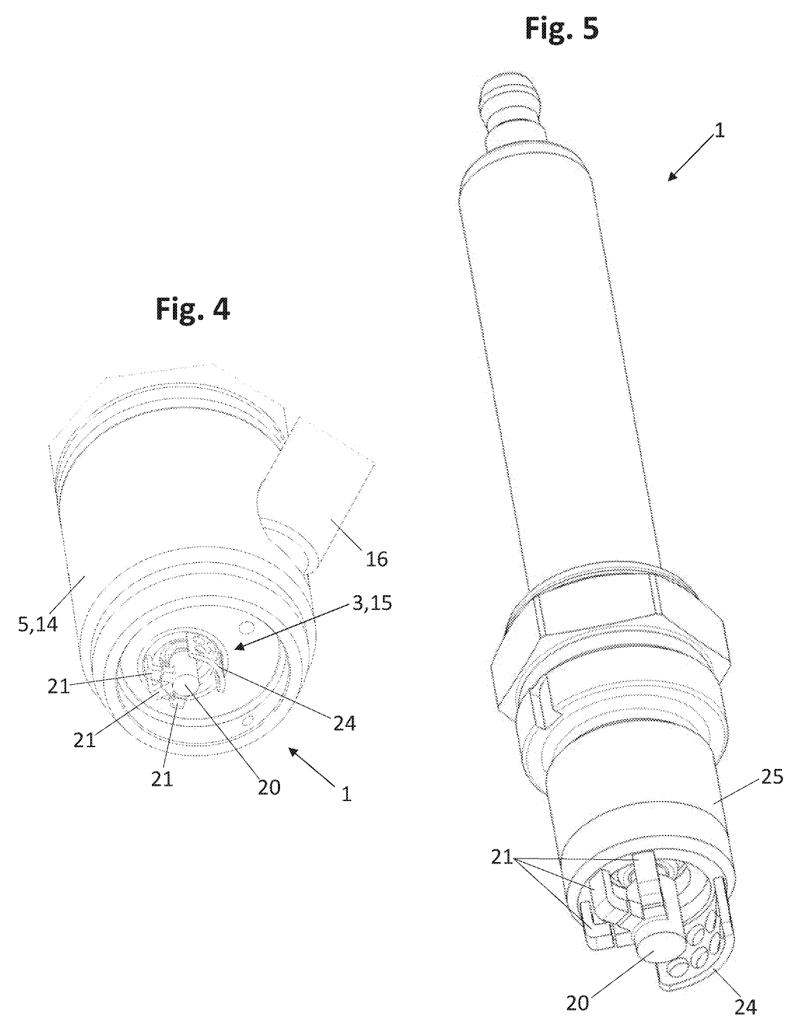

This spark plug 3 arranged inside the spark plug sleeve 14 is furthermore shown by FIG. 4 in a perspective view, wherein the pre-chamber component part 17 is hidden to provide a direct view from side of the combustion chamber onto the spark plug 3.

FIG. 5 further discloses a perspective view of the spark plug 3 in isolation, which spark plug 3 is also used by the embodiments of FIG. 3 and 4.

In fact, the embodiment of FIG. 3 does essentially correspond to the embodiment shown by FIG. 2, apart from the spark plug 3.

The spark plug 3 shown by FIG. 3 to 5 comprises a longitudinal extension along a longitudinal axis 4, wherein at a first end facing the combustion chamber when the spark plug 3 is mounted in the internal combustion engine a middle electrode 20 and three ground electrodes 21 are provided.

Therefore, there are spark gaps 22 are provided which are arranged between the middle electrode 20 and each of the three ground electrodes 21.

The spark gaps 22 of the spark plug 3 are arranged asymmetrically with respect to the middle electrode 20 and/or the longitudinal axis 4.

By use of such a spark plug 3 it is furthermore possible to move or arrange the spark gap 22 (and therefore the point of start of ignition) into an eccentrically position inside the pre-chamber volume 18.

To orient the spark plug (and therefore the eccentrical spark gaps 22) inside the pre-chamber volume 18 the positioning device 6 is used.

The three ground electrodes 21 of the spark plug 3 are arranged in an azimuthal area spanning approximate 120 degrees in relation to the longitudinal axis 4 and/or the middle electrode 20.

The spark plug 3 comprises a flow control element 24 surrounding the middle electrode 20 with respect to the longitudinal axis 4.

The flow control element 24 is arranged opposite of the three ground electrodes 21 with respect to the longitudinal axis 4.

The flow control element 24 is also arranged in an azimuthal area spanning approximately 120 degrees in relation to the longitudinal axis 4 and/or the at least one middle electrode 20.

As can be seen, the flow control element 24 is formed by a separate component part, which separate component part is arranged at the housing 25 of the spark plug 3. The housing 25 and the at least one separate component part are connected by welding, particularly preferably laser beam welding.

The flow control element 24 has a base shape of a part of a circular cylinder.

The ground electrode 20 comprises a central electrode carrier 26 extending along the longitudinal axis 4, wherein the middle electrode is attached to the electrode carrier 26.

The three ground electrodes 21 can be fixed by laser beam welding to the housing 25 of the spark plug 3.

### USED REFERENCE SIGNS

1 arrangement
2 igniter
3 spark plug
4 longitudinal axis
5 component part
6 positioning device
7 latch
8 centerline of the latch
9 pin
10 grab screw
11 locking profile
12 groove
13 bore
14 spark plug sleeve
15 ignition device
16 pre-chamber injector
17 pre-chamber component part
18 pre-chamber volume
19 pre-chamber gas channel
20 middle electrode
21 ground electrode
22 spark gap
23 transfer passages
24 flow control element
25 housing
26 central electrode carrier
27 mounting portion

1. A system, comprising:
a spark plug configured to ignite a combustible gaseous fuel mixture in an internal combustion engine, wherein the spark plug comprises:
a longitudinal extent along a longitudinal axis;
at least one middle electrode and at least two ground electrodes at a first end facing the combustion chamber when the spark plug is mounted in the internal combustion engine; and
at least two spark gaps arranged between the at least one middle electrode and each of the at least two ground electrodes respectively, wherein the at least two spark gaps are arranged asymmetrically with respect to the at least one middle electrode or the longitudinal axis of the spark plug.

2. The system of claim 1, wherein the at least two ground electrodes are arranged in an azimuthal area spanning 170 degrees in relation to the longitudinal axis and/or the at least one middle electrode.

3. The system of claim 1, comprising a flow control element partially surrounding the at least one middle electrode with respect to the longitudinal axis.

4. The system of claim 3, wherein the flow control element is arranged with respect to the longitudinal axis opposite of the at least two ground electrodes.

5. The system of claim 4, wherein the flow control element is arranged in an azimuthal area spanning 170 degrees in relation to the longitudinal axis and/or the at least one middle electrode.

6. The system of claim 3, wherein the flow control element is formed by at least one separate component part arranged at a housing of the spark plug, wherein the housing and the at least one separate component part are connected by a welded joint.

7. The system of claim 3, wherein the flow control element has a base shape of a part of a cylinder.

8. The system of claim 1, comprising a central electrode carrier extending along the longitudinal axis, wherein at least one middle electrode is attached to the central electrode carrier.

9. The system of claim 8, wherein the at least one middle electrode projects orthogonally with respect to the longitudinal axis from the central electrode carrier towards the at least two ground electrodes.

10. The system of claim 1, wherein the at least two ground electrodes are fixed to a housing of the spark plug.

11. The system of claim 10, wherein the housing of the spark plug further comprises a mounting portion configured to mount the spark plug in the internal combustion engine, wherein the mounting portion comprises a thread.

12. The system of claim 1, comprising an electrical connection for connecting the spark plug with an electrical power supply at a second end of the spark plug facing away from the first end.

13. The system of claim 1, wherein the at least two spark gaps are arranged asymmetrically with respect to the at least one middle electrode and the longitudinal axis of the spark plug.

14. The system of claim 1, comprising:
a component part configured to receive at least part of the spark plug, wherein the spark plug is disposed in the component part in a given azimuthal position relative to the longitudinal axis; and
a positioning device configured to lock the spark plug in the given azimuthal position.

15. The system of claim 14, comprising the internal combustion engine having the spark plug, the component part, and the positioning device.

16. A system, comprising:
at least one middle electrode and at least two ground electrodes of a spark plug, wherein the at least one middle electrode and the at least two ground electrodes are configured to be at a first end facing the combustion chamber when the spark plug is mounted in the internal combustion engine; and
at least two spark gaps arranged between the at least one middle electrode and each of the at least two ground electrodes respectively, wherein the at least two spark gaps are arranged asymmetrically with respect to the at least one middle electrode or a longitudinal axis of the spark plug.

17. The system of claim 16, comprising the internal combustion engine having the spark plug, wherein the spark plus has the at least one middle electrode, the at least two ground electrodes, and the at least two spark gaps.

18. The system of claim 16, wherein the at least two ground electrodes are arranged in an azimuthal area spanning 170 degrees in relation to the longitudinal axis and/or the at least one middle electrode.

19. A method, comprising:
generating a spark, via a spark plug, to ignite a combustible gaseous fuel mixture in an internal combustion engine, wherein the spark plug comprises:
a longitudinal extent along a longitudinal axis;
at least one middle electrode and at least two ground electrodes at a first end facing the combustion chamber when the spark plug is mounted in the internal combustion engine; and
at least two spark gaps arranged between the at least one middle electrode and each of the at least two ground electrodes respectively, wherein the at least two spark gaps are arranged asymmetrically with respect to the at least one middle electrode or the longitudinal axis of the spark plug.

20. The method of claim 19, wherein the at least two ground electrodes are arranged in an azimuthal area spanning 170 degrees in relation to the longitudinal axis and/or the at least one middle electrode.
